(19) United States
(12) Patent Application Publication
(10) Pub. No.: US 2004/0000255 A1
(43) Pub. Date: Jan. 1, 2004

(54) Compound for flex sole

(75) Inventor: Homar Hernandez, Boca Raton, FL (US)

Correspondence Address: DARBY & DARBY P.C., P. O. BOX 5257, NEW YORK, NY, 10150-5257, US

(73) Assignee: BBC International Ltd.

(21) Appl. No.: 10/175,521

(22) Filed: Jun. 18, 2002

(51) Int. Cl. C09K 3/00

(52) U.S. Cl. 106/38

(57) ABSTRACT

The present invention discloses a compound and a method for a cushion pad that is bonded to an outsole without the need for glue or other adhesives. This cushion pad can be softer and more flexible then the outsole but can be similar enough in composition to be recyclable without having to separate it from the outsole. The compound can consist of a styrene-butadiene-styrene triblock copolymer, ethyl-vinyl-acetate, peroxide, a filler agent, and a blowing agent. The combination of these materials will form a high rubber content foam sheet that is very soft and shock adsorbing. This process can use the above compound to manufacture a rubber outsole with an integrated cushioning pad that can be manufactured in one step.

### FIELD OF THE INVENTION

The invention relates to footwear or athletic shoes and, more particularly, to a compound for a flexible outsole and a method for making a flexible outsole for such shoes using ethyl-vinyl-acetate (EVA).

### BACKGROUND OF THE INVENTION

Footwear can be designed to provide a variety of stylistic and functional benefits. A particular functional benefit is the comfort the shoe provides the wearer. When walking or running, in particular, the flexibility and shock absorbing capability of the shoe can determine the amount of comfort provided to the foot of the shoe wearer. Two other factors that contribute to the functional benefits of a shoe are the shoe's weight and the support it provides the wearer's foot.

Shoes that are normally worn for active use, e.g., extensive walking or fitness sports, typically consist of an upper made of canvas, leather or other supple fabric material, and an outsole joined to the upper and typically made of rubber, leather, graphite or other durable material. The outsole has a bottom that contacts the ground when the shoe wearer is walking or running. The construction of the outsole is critical to the flexibility, support and wearability of the shoe. However, conventional hard and rigid materials known in the art for use on outsoles, such as rubber, graphite or leather, have limited flexibility and support, and thus limit the comfort of the shoe for the wearer.

To counteract the hardness and rigidity of a conventional outsole, cavities have been molded into the outsole to allow for the inclusion of cushioning pads. See, U.S. Pat. No. 6,367,172 to Hernandez. These cushioning pads may be formed of an ethyl-vinyl-acetate (EVA), a material that is softer and more flexible then the material of the outsole which is typically made of thermal plastic rubber (TPR).

To increase the flexibility of the outsole, ribs have also been formed surrounding the cavities. These rib structures are difficult to mold and form through standard injection molding techniques. Also, the cushioning pad is typically affixed to the outsole using adhesives. The adhesives are an added expense and create environmental hazards, i.e., the adhesives are typically flammable and emit noxious fumes. The flammability and the fumes should be guarded against, and again, this causes an increase in expenses. Lastly, any adhesive step will naturally include a required “drying” time for the adhesive to set. This increases the time required to produce one outsole and thus slows overall production.

Therefore, there is a need for a shoe with a softer pad bonded to an outsole. The bonding process should be performed without glue in order to remove the environmental hazards, costs and delays. The process should also be incorporated into the standard outsole molding process. By incorporating the bonding into an existing molding step, it will remove an extra step from the production of the outsole, and thus reduce errors, lower costs and lead to further production.

### SUMMARY OF THE INVENTION

The present invention discloses a material and a method of making a cushion pad that is bonded to an outsole or a shoe without the need for glue or other adhesives. This cushion pad can be made softer and more flexible then the outsole. The material can be a compound that consists essentially of a styrene-butadiene-styrene triblock copolymer, ethyl-vinyl-acetate (EVA), peroxide, a filler agent and a blowing agent. The combination of these materials will form a high rubber content foam sheet that is very soft and shock adsorbing.

The primary embodiment of the cushing pad can be produced from a type of styrene-butadiene-styrene triblock copolymer (SBS), known as thermal plastic rubber (TPR), and be in proportion of the TPR in the range of about 50% to about 100% by weight of the rubber and EVA in the range of about 0% to about 50% by weight. “Rubber” is defined herein as the combination of SBS and EVA. The filler agent can be calcium carbonate and can range from about 0% to about 15% by weight of the total compound. Additionally, the curing agent can be peroxide and can range from about 0.4% to about 1% by weight of the total compound.

The outsole compound can consist of SBS in the range of about 50% to about 100% by weight of the rubber and EVA in the range of about 45% to about 60% by weight of the rubber. Additionally, besides the rubber, the outsole compound can include a filler and a processing oil. The filler agent can be calcium carbonate or clay and can range from about 2% to about 7% by weight of the total compound. The processing oil can be naphthenic or paraffinic based and can range from about 40% to about 50% by weight of the total compound.

Additionally, the cushion pad and outsole compounds can be described in the terms of parts per hundred parts of rubber (“phr”). Thus, for the cushion pad, SBS is added at about 50 phr to about 100 phr. To equate to a full 100 parts of rubber, EVA can be added in the range of about 0 phr to about 50 phr. The curing agent may be added in the range of about 0.5 to about 1.0 phr. The filler agent may be added in the range of about 0 to about 10 phr and the blowing agent may be added in the range of about 3 to about 5 phr.

The outsole compound can be formed from SBS in the range of about 50 phr to about 100 phr and EVA in the range of about 45 phr to about 60 phr. The processing oil may be added in the range of about 80 phr to about 120 phr and the filler agent, may be added in the range of about 5 phr to about 15 phr.

The present invention includes a manufacturing process. This process can use the above compounds to manufacture a rubber outsole with an integrated cushioning pad. This process involves mixing and kneading the compound for the cushion pad, and then rolling the cushion pad compound into a sheet approximating 2.5 millimeters in thickness. Then a cushion pad mold is heated to approximately 170° Centigrade and the cushion pad sheet is injected into the heated cushion pad mold. The mold is then clamped and a pressure of approximately 150 kg/cm² is provided. The cushion pad compound is then cured. When it is removed, the cushion pad will typically have a density ranging of about 0.2 grams/cm³ to about 0.4 grams/cm³. The cushion pad is then placed in the outsole mold and the outsole compound is then injected into the outsole mold. When cured, the outsole and cushon pad will be bonded by that single step.

In preferred exemplary embodiment, a second plantar region pad can also be formed using the compound and method similar to that of the cushion pad. The cushion pad may be of a certain density and the plantar region pad of a greater density. The plantar region pad is then affixed to the cushion pad prior to the cushion pad being molded to the outsole.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a perspective view of the apparatus and intermediate products used in molding the cushion pad and outsole according to the invention;

FIG. 2 is flow diagram of the process of the present invention using a single cushion pad;

FIG. 3 is flow diagram of the additional process steps for including plantar pad in the exemplary embodiment;

FIG. 4 is a top view of the completed combination outsole/cushioning pad with the bottom of the sole cut away to show the invention;

FIG. 5 is a cross-sectional view taken along line 5-5 of FIG. 4 and looking in the direction of the arrows;

FIG. 6 is a cross-sectional view taken along line 6-6 of FIG. 4 and looking in the direction of the arrows;

FIG. 7 is a cross-sectional view taken along line 7-7 of FIG. 4 and looking in the direction of the arrows;

FIG. 8 is a cross-sections view taken along line 8-8 and looking in the direction of the arrow, illustrating the plantar region pad of the preferred exemplary embodiment; and

FIG. 9 is an exploded prospective view of the shoe of the preferred exemplary embodiment.

### DETAILED DESCRIPTION OF THE PREFERRED EMBODIMENT

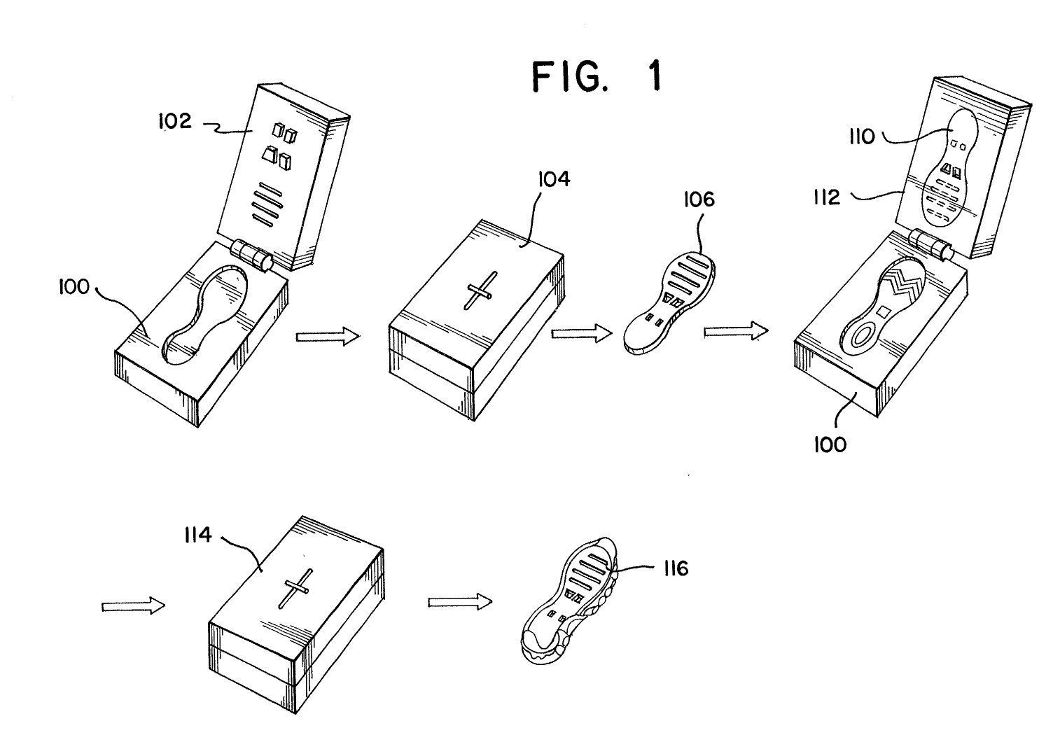

Referring now to FIG. 1, therein is shown in detail the molding steps of the invention. FIG. 1 shows that a cushion mold 100 is designed with an upper mold portion 102, which is shaped in the form of the final cushioning pad's top surface. The mold is then sealed and the cushioning pad compound 104, which is made of approximately 30% EVA and 70% TPR by weight, is injected into the mold. The filler agent can be calcium carbonate and can range from about 0% to about 15% by weight of the total compound. Additionally, the curing agent can be peroxide and can range from about 0.4% to about 1% by weight of the total compound.

The outsole compound can consist of SBS in the range of about 50% to about 100% by weight of the rubber and EVA in the range of about 45% to about 60% by weight of the rubber. Additionally, the outsole compound can include a filler and a processing oil. The filler agent can be calcium carbonate or clay and can range from about 2% to about 7% by weight of the total compound. The processing oil can be naphthenic or paraffinic based and can range from about 40% to about 50% by weight of the total compound.

The compound is then allowed to cure. Once cured, a fully formed cushioning pad 106 is produced. This cushioning pad 106 is then inserted in a recess 110 in the outsole upper mold 112. The outsole mold 108 is then sealed and the outsole compound, which is a dry styrene-butadiene-styrene triblock copolymer, ethyl-vinyl-acetate, curing agent, filler agent, blowing agent and a processing oil 114, is injected into the outsole mold 108. It is cured to form the outsole/cushioning pad combination 116. In a preferred embodiment curing agent is peroxide, the filler agent is calcium carbonate, the blowing agent is azodicarbonamide and the processing oil is Naphthalene oil.

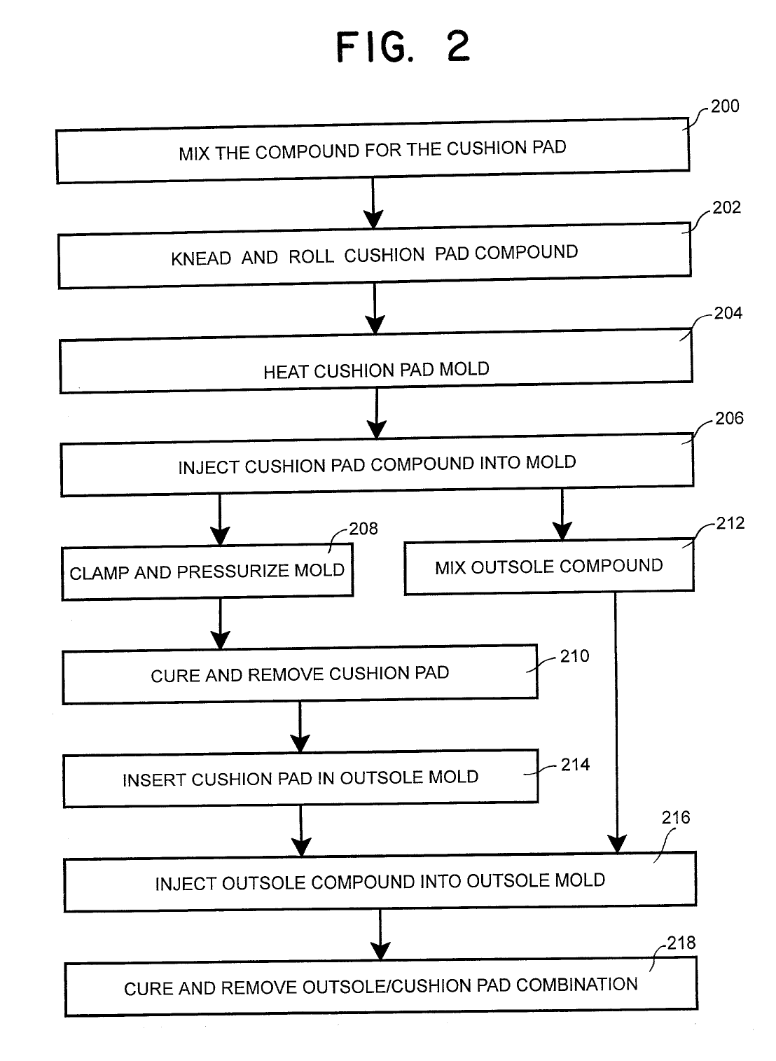

FIG. 2 is a flow chart of the process for manufacturing the outsole/cushioning pad combination. First, the compound for the cushion pad is produced by mixing a styrene-butadiene-styrene triblock copolymer (SBS), ethyl vinyl acetate (EVA), curing agent, filler agent, and a blowing agent in a kneader (step 200). Then the cushion pad compound is kneaded until well combined. It is then rolled into a sheet approximately 2.5 millimeters in thickness (step 202). The cushion pad mold can be heated to a range of temperatures of about 160° Centigrade to about 180° Centigrade (step 204). Once at the proper temperature, the cushion pad compound is injected into the heated sealed cushion pad mold (step 206). The cushion pad mold is then pressurized to a pressure ranging from about 140 kg/cm² to about 160 kg/cm² (step 208). The cushion pad should then be cured in the mold at the end of the curing, the fully formed pad is removed from the mold. This cushion pad will typically have a density of about 0.2 grams/cm³ to about 0.4 grams/cm³ (step 210).

Then the compound for the outsole is mixed by combining a dry styrene-butadiene-styrene triblock copolymer, ethyl-vinyl-acetate, filler, and a processing oil (step 212). Next, the cushion pad is placed in a recess in the upper part of the outsole mold 112 (step 214). The outsole compound is then injected into the outsole mold (step 216). Lastly, the outsole/cushion pad combination is allowed to cure and then removed from the mold (step 218).

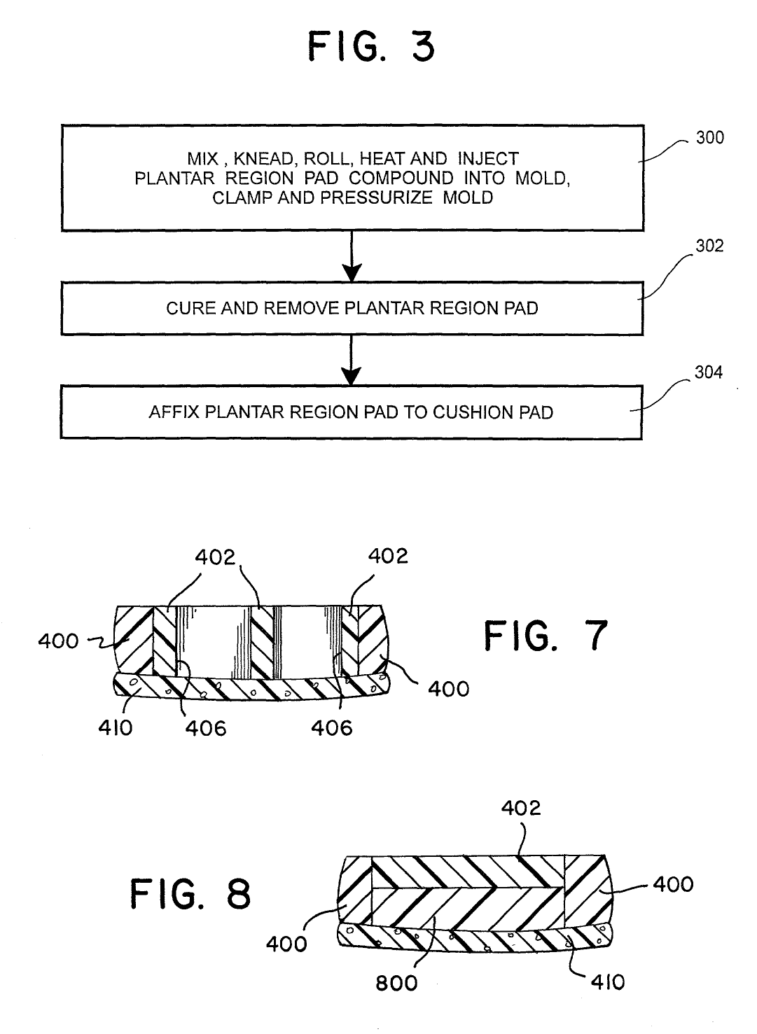

FIG. 3 is a flow chart illustrating the additional steps to produce an exemplary embodiment of the invention with a planter pad. The method involves repeating steps 200 through 208 in order to form a plantar region pad (step 300). Next, the cured plantar region pad is removed the component, for the compound used to form the plantar region are selected so that it has a density greater than the density of the cushion pad. Lastly, the plantar region pad may be affixed to the cushion pad prior to the insertion of the cushion pad into the outsole mold step 214 (step 304).

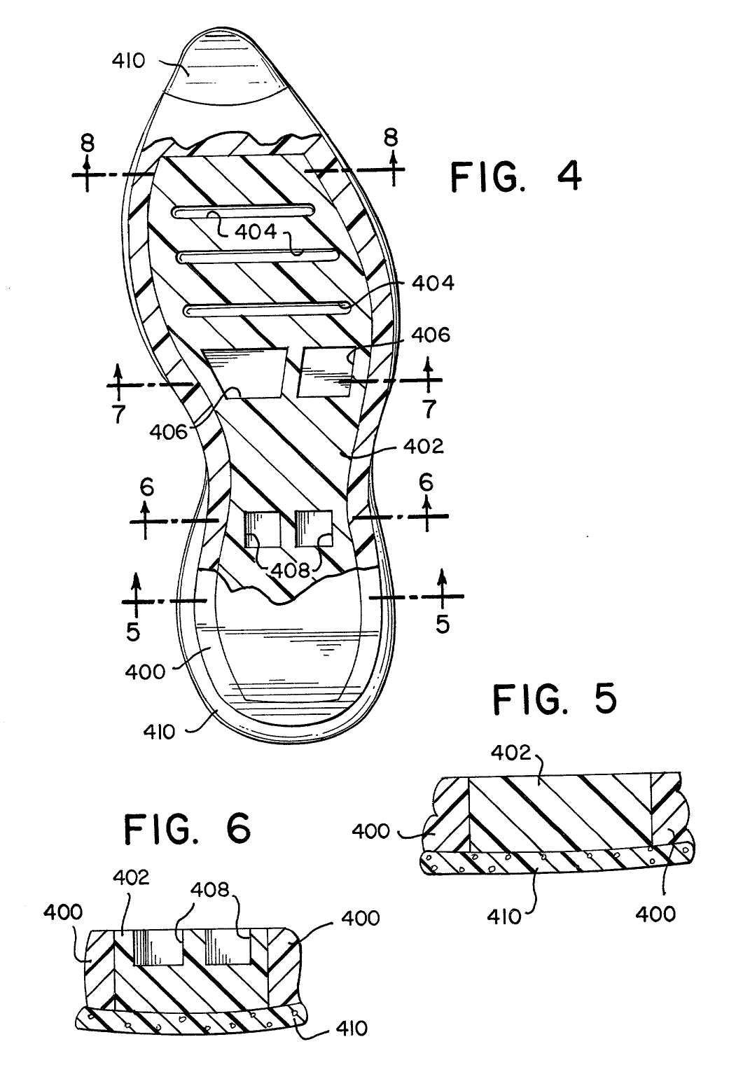

Referring now to FIG. 4, the completed outsole/cushioning pad is illustrated with the bottom removed to show the interior structure. The TPR outsole 400 is molded around the EVA cushioning pad 402. The EVA cushioning pad can be molded to have front trenches or grooves 404 and, cavities 406 that contain other materials. The trenches 404 are formed in the EVA cushioning pad 402 and do not reach the TPR outsole 400. However, the cavities 406 reach down to the material of the outsole bottom 410. Another set of rear hollows 408 can also be molded in the pad. These hollows 408 are just formed in the EVA cushioning pad 402 and do not reach down to the TPR outsole 400. The trenches 404 and cavities 406 are used to add flexibility to the outsole 400. A portion of an outsole bottom 410 is shown in FIG. 4. A complete bottom can also be molded to the bottom of the TPR outsole 400 for extra durability.

FIG. 5 illustrates a cross-section through line 5-5 on FIG. 4. A TPR outsole 400 is molded around the EVA cushioning pad 402. Thus, it is not necessary to use glue or adhesives to keep it in place. Again, an outsole bottom 410 can also be molded to the bottom of the TPR outsole 400 for extra durability.

FIGS. 6 and 7 illustrate additional cross-sections through lines 6-6 and 7-7 respectfully on FIG. 4. A TPR outsole 400 is molded around the EVA cushinong pad 402. FIG. 6 illustrates the rear hollows 408 and that the hollows 408 do not go to the bottom of the EVA pad 402. However, the cavities 406 illustrated in FIG. 7 are molded so they penetrate completly through the EVA pad 402 and extend down to the material of the outsole bottom 410.

Referring to FIG. 8, here is illustrated a cross-section through the plantar region of the shoe. In an exemplary embodiment, a plantar region pad 800 is affixed to the bottom of the cushion pad 402 and extends to the outsole bottom 410. This plantar region pad 800 may be of a different density then the cushion pad 402. Typically, the plantar region pad 800 will have a greater density to provide more support.

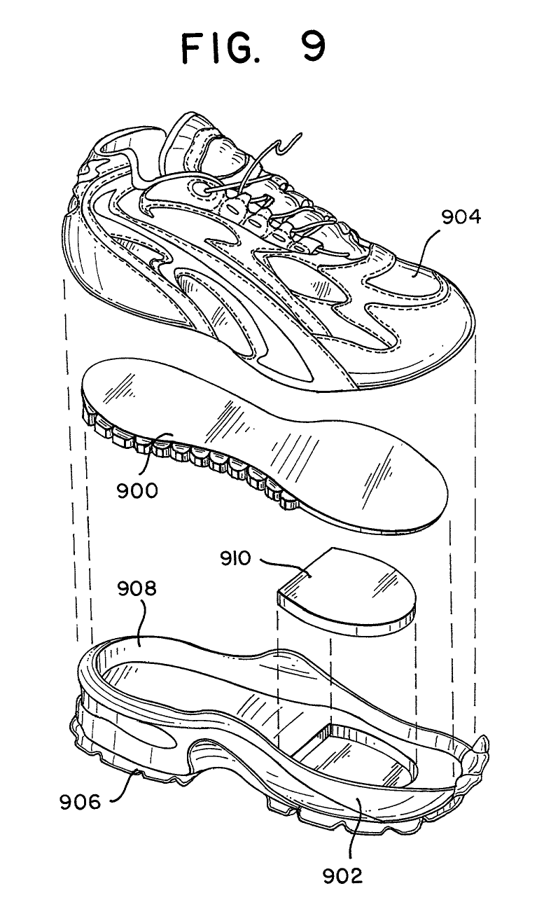

FIG. 9 illustrates an exploded perspective view of the shoe of the present invention. The shoe is comprised of a cushion pad 900, an outsole 902 and an upper 904. The outsole 902 also has a bottom 906. The cushion pad 900 is formed, either with or without an additional plantar region pad 910. Once formed, the cushion pad 900 is then molded to the outsole 902. This acts as if the outsole pad 900 is placed in a cavity 908 in the outsole 902, but it is actually formed inside for improved qualities as discussed above.

### EXAMPLE 1

An example of the preferred embodiment of the compounds si described below.

The cushion pad compound includes SBS in the range of about 50 to about 100 parts per hundred parts of rubber (“phr”). To equate to a full 100 parts of rubber, EVA can be added in the range of about 0 phr to about 50 phr.

The exemplary embodiment contains 70% by weight of SBS an 30% by weight of EVA wherein the EVA itself includes about 15% to about 18% vinyl acetate. Additionally, additives may be required to be added to the rubber to give it all of the properties of the current invention. Peroxide, a curing agent, may be added in the range of about 0.5 to about 1.0 phr. Also, calcium carbonate, a filler agent, may be added in the range of about 0 to about 10 phr. Lastly, azodicarbonamide, a blowing agent, may be added in the range of about 3 to about 5 phr.

A second portion of a shoe is the outsole and the exemplary embodiment of the outsole composition is again SBS in the range of about 50 to about 100 phr and EVA in the range of about 45 to about 60 phr. The additives for this compound may include naphthenic oils, a processing oil, may be added in the range of about 80 to about 120 phr. Lastly, calcium carbonate, a filler agent, may be added in the range of about 5 to about 15 phr.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed is:

1. A shoe sole comprised of a cushion pad and an outsole; said cushion pad composition consists of:
a styrene-butadiene-styrene triblock copolymer in the range of about 50 to about 100 parts per hundred parts of rubber (“phr”);
an ethyl vinyl acetate in the range of about 0 to about 50 phr;
a curing agent in the range of about 0.5 to about 1.0 phr;
a filler agent in the range of about 0 to about 10 phr;
a blowing agent in the range of about 3 to about 5 phr.

2. The shoe sole as defined in claim 1, wherein said ethyl vinyl acetate comprises about 15% to about 18% vinyl acetate.

3. The shoe sole as defined in claim 1, wherein said outsole composition comprising:
a dry styrene-butadiene-styrene triblock copolymer in the range of about 50 to about 100 phr;
a processing oil in the range of about 80 to about 120 phr;
an ethyl vinyl acetate in the range of about 45 to about 60 phr; and
a filler agent in the range of about 5 to about 15 phr.

4. The shoe sole as defined in claim 1, wherein said cushion pad having a particular density; and
further comprising a plantar region pad, having a different density then said cushion pad,
said plantar region pad composition consisting of:
a styrene-butadiene-styrene triblock copolymer in the range of about 50 to about 100 parts per hundred parts of rubber (“phr”);
a ethyl vinyl acetate in the range of about 0 to about 50 phr;
a curing agent in the range of about 0.5 to about 1.0 phr;
a filler agent in the range of about 0 to about 10 phr; and
a blowing agent in the range of about 3 to about 5 phr;
said plantar region pad being affixed to said cushion pad.

5. The shoe sole as defined in claim 1, wherein said filler agent can be selected from the group comprising carbon black, silica, calcium carbonate and clay.

6. The shoe sole as defined in claim 1, wherein said processing oil can be selected from the group comprising naphthenic, aromatic, and paraffinic oils.

7. The shoe sole as defined in claim 1, wherein said blowing agent is azodicarbonamide.

8. The shoe sole as defined in claim 1, wherein said curing agent is peroxide.

9. The shoe sole as defined in claim 1, wherein said cushion pad comprises a density ranging of about 0.2 grams/cm³ to about 0.4 grams/cm³.

10. A method of manufacturing a shoe sole comprising the steps:
(a) forming the compound for the cushion pad by mixing a styrene-butadiene-styrene triblock copolymer, ethyl vinyl acetate, a curing agent, a filler agent, and a blowing agent in a kneader;
(b) kneading said cushion pad compound;
(c) rolling said cushion pad compound into a sheet approximating 2.5 millimeters in thickness;
(d) heating a cushion pad mold to a range of temperatures of about 160° Centigrade to about 180° Centigrade;
(e) clamping said cushion pad mold;
(f) injecting said cushion pad compound into the said heated cushion pad mold;
(g) raising the pressure in the cushion pad mold from about 140 kg/cm² to about 160 kg/cm²;
(h) curing said cushion pad compound in said cushion pad mold;
(i) removing a cured cushion pad;
(j) forming a compound for said outsole by mixing a dry styrene-butadiene-styrene triblock copolymer, ethyl vinyl acetate, a curing agent, a filler agent, a blowing agent and a processing oil;
(k) placing said cushion pad in the outsole mold;
(l) changing said outside mold;
(m) injecting said outsole compound into the outsole mold;
(n) curing said outsole/cushion pad combination; and
(o) removing said outsole/cushion pad combination.

11. The method as defined in claim 10, further comprising the steps:
(a) forming the compound for the plantar region pad by mixing a styrene-butadiene-styrene triblock copolymer, ethyl vinyl acetate, a curing agent, a filler, agent, and a blowing agent in a kneader;
(b) kneading said plantar region pad compound;
(c) rolling said plantar region pad compound into a sheet approximating 2.5 millimeters in thickness;
(d) heating a plantar region pad mold to a range of temperatures of about 160° Centigrade to about 180° Centigrade;
(e) clamping said plantar region pad mold;
(f) injecting said plantar region pad compound into the said heated plantar region pad mold;
(g) raising the pressure in the plantar region pad mold to about 140 kg/cm² to about 160 kg/cm²;
(h) curing said plantar region pad compound in said plantar region pad mold;
(i) removing said cured plantar region pad from said mold,
(j) affixing said plantar region pad to said cushion pad prior to the placing step.

12. The method as defined in claim 10, wherein the plantar region pad has a density greater than the density of said cushion pad.

13. The method as defined in claim 10, wherein said filler agent is selected from the group comprising carbon black, silica, calcium carbonate and clay.

14. The method as defined in claim 10, wherein said processing oil is selected from the group comprising naphthenic, aromatic, and paraffinic oils.

15. The method as defined in claim 10, wherein said blowing agent is azodicarbonamide.

16. The method as defined in claim 10, wherein said curing agent is peroxide.

17. The method as defined in claim 10, wherein said cushion pad comprises a density ranging of about 0.2 grams/cm³ to about 0.4 grams/cm³.

18. A shoe comprising:
an upper; and
an outsole affixed to said upper, said outsole having cushion pad therein; said cushion pad composition consisting of:
a styrene-butadiene-styrene triblock copolymer in the range of about 50 to about 100 parts per hundred parts of rubber (“phr”);
an ethyl vinyl acetate in the range of about 0 to about 50 phr;
a curing agent in the range of about 0.5 to about 1.0 phr;
a filler agent in the range of about 0 to about 10 phr; and
a blowing agent in the range of about 3 to about 5 phr.

19. The shoe as defined in claim 18, wherein said ethyl vinyl acetate comprises about 15% to about 18% vinyl acetate.

20. The shoe as defined in claim 18, wherein said outsole composition comprising:
a dry styrene-butadiene-styrene triblock copolymer in the range of about 50 to about 100 phr;
a processing oil in the range of about 80 to about 120 phr;
an ethyl vinyl acetate in the range of about 45 to about 60 phr; and
a filler agent in the range of about 5 to about 15 phr.

21. A shoe as defined in claim 18, wherein said cushion pad having a particular density; and
further comprising a plantar region pad, said plantar region pad having a different density then said cushion pad,
said plantar region pad composition consisting of:
a styrene-butadiene-styrene triblock copolymer in the range of about 50 to about 100 parts per hundred parts of rubber (“phr”);
an ethyl vinyl acetate in the range of about 0 to about 50 phr;
a curing agent in the range of about 0.5 to about 1.0 phr;
a filler agent in the range of about 0 to about 10 phr; and
a blowing agent in the range of about 3 to about 5 phr;
said plantar region pad being affixed to said cushion pad.

22. The shoe as defined in claim 18, wherein said filler agent is selected from the group comprising carbon black, silica, calcium carbonate and clay.

23. The shoe as defined in claim 18, wherein said processing oil is selected from the group comprising naphthenic, aromatic, and paraffinic oils.

24. The shoe as defined in claim 18, wherein said blowing agent is azodicarbonamide.

25. The shoe as defined in claim 18, wherein said curing agent is peroxide.

26. The shoe as defined in claim 18, wherein said cushion pad comprises a density ranging of about 0.2 grams/cm³ to about 0.4 grams/cm³.

27. A method of manufacturing a shoe comprising the steps:
(a) forming the compound for the cushion pad by mixing a styrene-butadiene-styrene triblock copolymer, ethyl vinyl acetate, a curing agent, a filler agent, and a blowing agent in a kneader;
(b) kneading said cushion pad compound;
(c) rolling said cushion pad compound into a sheet approximating 2.5 millimeters in thickness;
(d) heating a cushion pad mold to a range of temperatures from about 160° Centigrade to about 180° Centigrade;
(e) clamping said cushion pad mold;
(f) injecting said cushion pad compound into the said heated cushion pad mold;
(g) raising the pressure in the cushion pad mold from about 140 kg/cm² to about 160 kg/cm²;
(h) curing said cushion pad compound in said cushion pad mold;
(i) removing a cured cushion pad;
(j) forming a compound for said outsole by mixing a dry styrene-butadiene-styrene triblock copolymer, ethyl vinyl acetate, a curing agent, a filler agent, a blowing agent and a processing oil;
(k) placing said cushion pad in the outsole mold;
(l) changing said outside mold;
(m) injecting said outsole compound into the outsole mold;
(n) curing said outsole/cushion pad combination; and
(o) removing said outsole/cushion pad combination.

28. The method as defined in claim 27, further comprising:
(a) forming the compound for the plantar region pad by mixing a styrene-butadiene-styrene triblock copolymer, ethyl vinyl acetate, a curing agent, a filler agent, and a blowing agent in a kneader;
(b) kneading said plantar region pad compound;
(c) rolling said plantar region pad compound into a sheet approximating 2.5 millimeters in thickness;
(d) heating a plantar region pad mold to a range of temperatures from about 160° Centigrade to about 180° Centigrade;
(e) clamping said plantar region pad mold;
(f) injecting said plantar region pad compound into the said heated plantar region pad mold;
(g) raising the pressure in the plantar region pad mold from about 140 kg/cm² to about 160 kg/cm²;
(h) curing said plantar region pad compound in said plantar region pad mold;
(i) removing said cured plantar region pad with a density greater than said density of said cushion pad,
(j) affixing said plantar region pad to said cushion pad prior to the placing step.

29. The method as defined in claim 27, wherein the plantar region pad has a density greater than the density of said cushion pad.

30. The method as defined in claim 27, further comprising the step of bonding said outsole/cushion pad to an upper.

31. The method as defined in claim 27, wherein said filler agent is selected from the group comprising carbon black, silica, calcium carbonate and clay.

32. The method as defined in claim 27, wherein said processing oil is selected from the group comprising naphthenic, aromatic, and paraffinic oils.

33. The method as defined in claim 27, wherein said blowing agent is azodicarbonamide.

34. The method as defined in claim 27, wherein said curing agent is peroxide.

35. The method as defined in claim 27, wherein said cushion pad comprises a density ranging of about 0.2 grams/cm³ to about 0.4 grams/cm³.
